(19) United States
(12) Patent Application Publication
(10) Pub. No.: US 2025/0004610 A1
(43) Pub. Date: Jan. 2, 2025

(54) PRESENTATION AND CONTROL OF USER INTERACTION WITH A USER INTERFACE ELEMENT

(71) Applicant: Capital One Services, LLC, McLean, VA (US)

(72) Inventors: Erik Jay Salazar DE LEON, Richmond, VA (US); Thomas DOHAN, II, Elmhurst, IL (US); Xiang LAN, South Orange, NJ (US); Min Jung KIM, Fairfax, VA (US); Albert BERGER, Arlington, VA (US); John HEINER, Midlothian, VA (US); Vivian WANG, Mclean, VA (US); Jennifer L. ELLISON, New Kent, VA (US)

(21) Appl. No.: 18/884,371

(22) Filed: Sep. 13, 2024

Related U.S. Application Data
(63) Continuation of application No. 17/660,263, filed on Apr. 22, 2022.

(51) Int. Cl. G06F 3/0482; G06Q 20/10; G06Q 40/02

(52) U.S. Cl. CPC G06F 3/0482; G06Q 20/108; G06Q 40/02

(57) ABSTRACT

In some implementations, a system may receive a user identifier associated with a user account, and may identify account identifiers associated with the user account. The system may obtain account information associated with the account identifiers, and may determine priority levels for the account identifiers based on the account information. A primary account identifier may be associated with a highest priority level. The system may transmit a first set of user interface (UI) data indicating account UI elements, corresponding to the account identifiers, and an order of the account UI elements based on the priority levels. A primary account UI element, corresponding to the primary account identifier, may be arranged first in the order. The first set of UI data may indicate a first set of the account information to be visually presented on the account UI elements and associated with the account identifiers corresponding to the account UI elements.

This application is a continuation of U.S. patent application Ser. No. 17/660,263, filed Apr. 22, 2022, which is incorporated herein by reference in its entirety.

### BACKGROUND

A display of a user device may display a user interface (e.g., a graphical user interface). A user interface may permit interactions between a user of the user device and the user device. In some cases, the user may interact with the user interface to operate and/or control the user device to produce a desired result. For example, the user may interact with the user interface of the user device to cause the user device to perform an action. Additionally, the user interface may provide information to the user.

### SUMMARY

Some implementations described herein relate to a system for providing data for presentation of a user interface element. The system may include one or more memories and one or more processors communicatively coupled to the one or more memories. The one or more processors may be configured to receive, from a user device associated with a user account of a user, a user identifier associated with the user account. The one or more processors may be configured to identify, from a user profile database and based on the user identifier, a plurality of account identifiers associated with the user account. The one or more processors may be configured to obtain, from the user profile database, account data indicating account information associated with the plurality of account identifiers. The one or more processors may be configured to determine priority levels for the plurality of account identifiers based on the account information, wherein a primary account identifier, of the plurality of account identifiers, is associated with a highest priority level of the priority levels. The one or more processors may be configured to transmit, to the user device, a first set of user interface data indicating a plurality of account user interface elements corresponding to the plurality of account identifiers, wherein the first set of user interface data may indicate an order of the plurality of account user interface elements based on the priority levels of the plurality of account identifiers, wherein a primary account user interface element, of the plurality of account user interface elements and corresponding to the primary account identifier, may be arranged first in the order, and wherein the first set of user interface data may indicate, for the plurality of account user interface elements, a first set of the account information to be visually presented on the plurality of account user interface elements, and the first set of the account information may be associated with the plurality of account identifiers corresponding to the plurality of account user interface elements.

Some implementations described herein relate to a method of providing data for presenting a user interface element. The method may include identifying, by a system that includes at least one processor and from a user profile database, a plurality of account identifiers associated with a user account. The method may include determining, by the system, a plurality of priority levels corresponding to the plurality of account identifiers based on one or more factors associated with account information in connection with the user account. The method may include transmitting, by the system and to a user device associated with the user account, a first set of user interface data indicating a plurality of account user interface elements corresponding to the plurality of account identifiers, wherein the first set of user interface data indicates an order, in which the plurality of account user interface elements are to be presented on the user device, based on the plurality of priority levels corresponding to the plurality of the plurality of account identifiers. The method may include receiving, by the system and from the user device, selection data indicating a selection of a selected one of the plurality of account user interface elements corresponding to a selected account identifier of the plurality of account identifiers. The method may include transmitting, to the user device, a second set of user interface data indicating the selected one of the plurality of account user interface elements and at least some of the account information to be visually presented within the selected one of the plurality of account user interface elements, wherein the at least some of the account information is associated with the selected account identifier.

Some implementations described herein relate to a user device configured to present a user interface element. The user device configured may include a memory and one or more processors communicatively coupled to the memory. The one or more processors may be configured to present, on a user interface associated with a user account, a plurality of interaction elements, of the user interface element, corresponding to a plurality of account identifiers associated with the user account, wherein the plurality of interaction elements may be presented, on the user interface, in an order in which a primary interaction element, of the plurality of interaction elements, is first in the order, and the plurality of interaction elements may include first rectangular-shaped elements and first sets of account information presented within the first rectangular-shaped elements, wherein the first sets of account information may be associated with the plurality of account identifiers corresponding to the plurality of interaction elements. The one or more processors may be configured to detect a user interaction, with the user device, that indicates a selected interaction element of the plurality of interaction elements, wherein the selected interaction element corresponds to a selected account identifier of the plurality of account identifiers. The one or more processors may be configured to present, on the user interface and based on the user interaction, a second rectangular-shaped element and a second set of account information presented within the second rectangular-shaped element, wherein the second set of account information is associated with the selected account identifier, and wherein the second rectangular-shaped element is presented instead of at least some of the first rectangular-shaped elements.

### BRIEF DESCRIPTION OF THE DRAWINGS

FIGS. 1A-1C are diagrams of an example implementation relating to presentation and control of user interaction with a user interface element.

FIG. 2 is a diagram of an example environment in which systems and/or methods described herein may be implemented.

FIG. 3 is a diagram of example components of one or more devices of FIG. 2.

FIGS. 4-6 are flowcharts of example processes relating to presentation and control of user interaction with a user interface element.

### DETAILED DESCRIPTION

The following detailed description of example implementations refers to the accompanying drawings. The same reference numbers in different drawings may identify the same or similar elements.

A user may have a user account (e.g., with an institution), which further may include or be associated with one or more sub-accounts. The user may desire to access a particular sub-account or to generally view information for each or all of the sub-accounts. To do so, the user may log in to the user account via a user device (e.g., a mobile phone). The user device may present multiple user interfaces (UIs) or UI elements corresponding to each sub-account. The multiple UIs or UI elements generally present the same type of information by which the user may identify the sub-accounts and in a particular order (e.g., numeric order) that remains the same each time the user accesses the user account. However, often a particular sub-account may require more immediate attention than the other sub-accounts (for example, if there is abnormal activity with the particular sub-account and/or if the sub-account has been flagged with an alert (e.g., a fraud alert)). Accordingly, it is desirable to have a user interface (UI) that presents the sub-accounts to the user in a particular order, based on a particular priority of the sub-accounts, in an efficient manner.

Some implementations described herein enable a system to provide data for presentation of a UI element on a user device that provides multiple account UI elements corresponding to multiple sub-accounts of a user. The system may determine respective priority levels for the multiple sub-accounts based on account information associated with the sub-accounts. The multiple UI elements may be presented on a user device in an order based on the priority levels, with a primary UI element corresponding to a primary sub-account having a highest priority level, displayed first in the order. The account information upon which the priority levels may be determined may include account totals (e.g., account balances), account activity (e.g., account usage in a particular time frame and/or deviation in the particular time frame from an average amount of usage), account alerts (e.g., fraud alerts), account action dates (e.g., deadlines), and/or account types (e.g., credit, savings, checking, or rewards). By providing multiple account UI elements together with account information and in a particular order based on the account information, the system is able to efficiently utilize the available space provided by a screen of the user device to efficiently present the account information to the user in a manner requiring minimal user interaction, thereby conserving computing memory and resources.

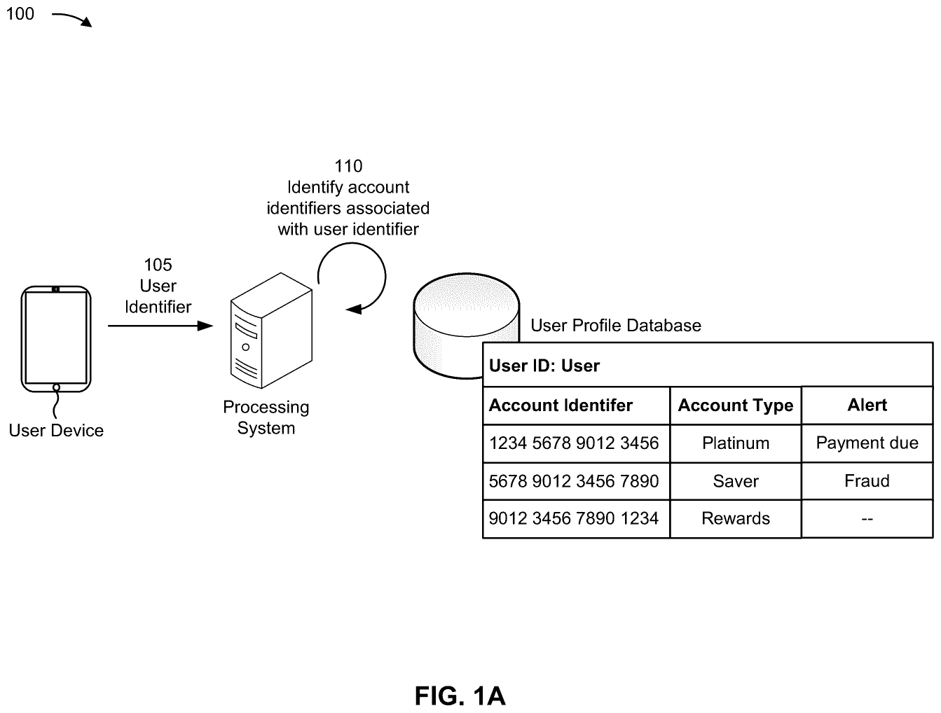

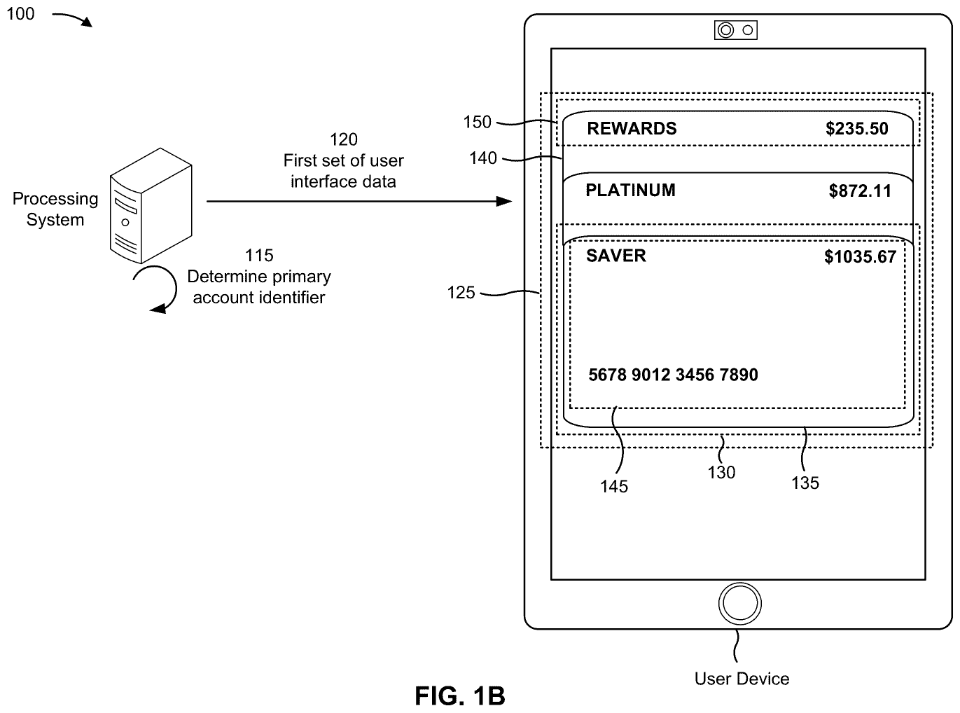

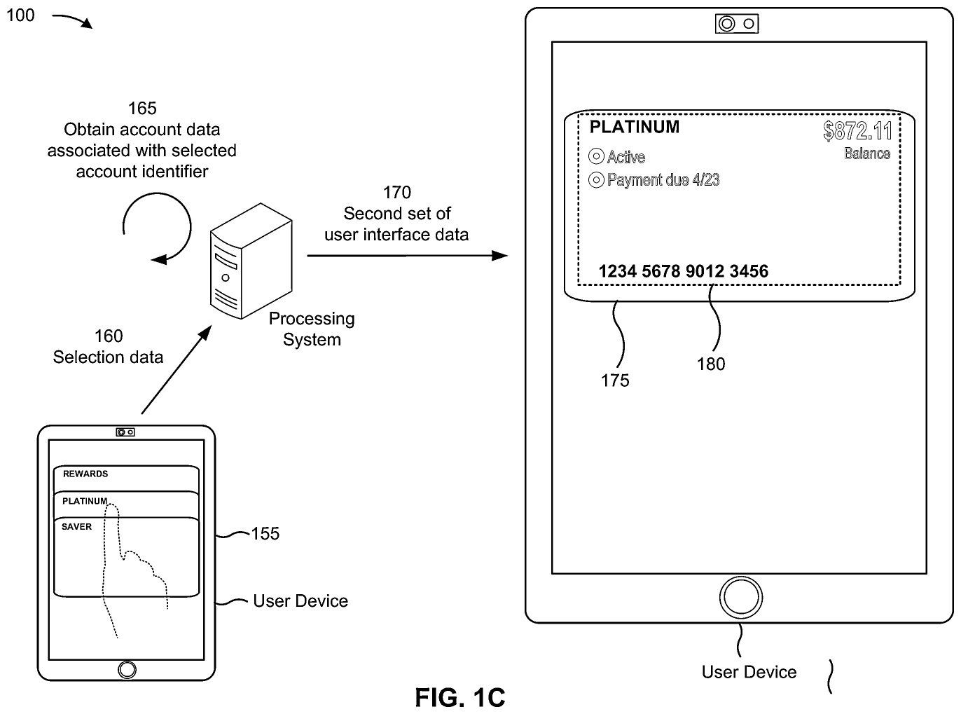

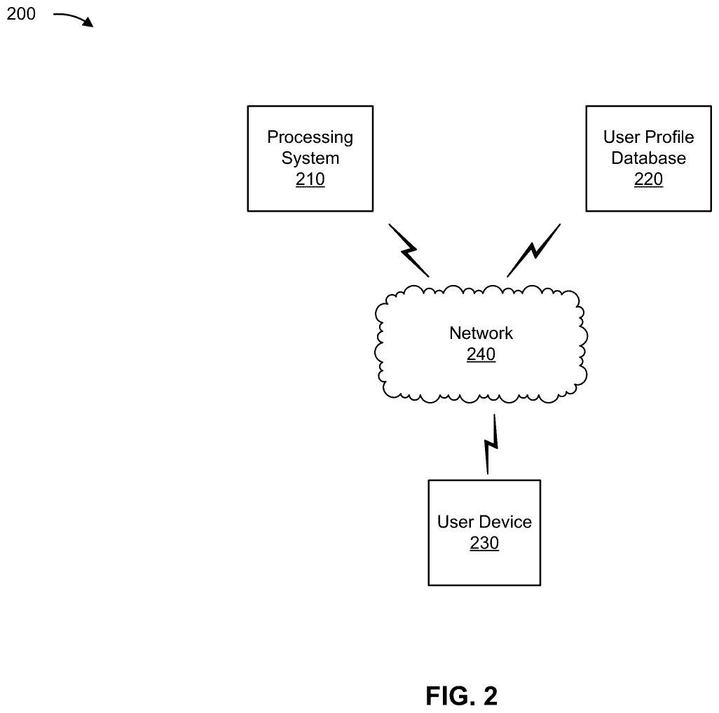

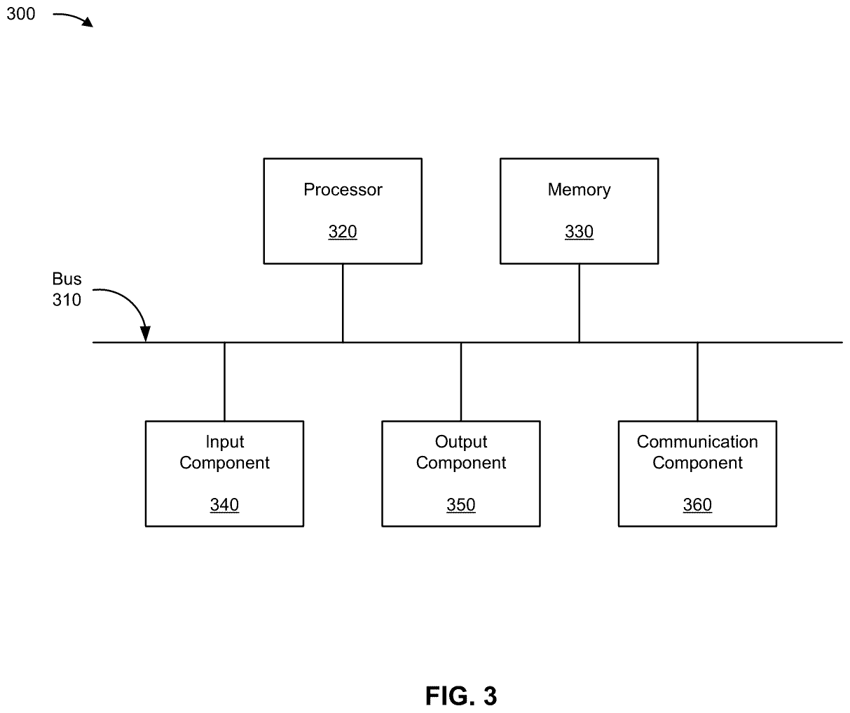

FIGS. 1A-1C are diagrams of an example 100 associated with presentation and control of user interaction with a user interface element. As shown in FIGS. 1A-1C, example 100 includes a processing system, a user profile database, and a user device. These devices are described in more detail in connection with FIGS. 2 and 3.

As shown in FIG. 1A, a user may access an account of the user (e.g., a user account) via the user device, such as via an application installed on the user device or via a web-based application accessed on the user device over a network (as described in more detail below). The user and user account may be associated with a user identifier (e.g., the user's login or username) by which the user and user account may be identified. The user account may have one or more accounts (also referred to as sub-accounts). As shown by reference number 105, the user device may transmit, and the processing system may receive, the user identifier, such as when the user logs into the user account (e.g., via the application installed on the user device or via the web-based application).

As shown by reference number 110, based on the user identifier, the processing system may access account information associated with the user identifier and the user account (e.g., from the user profile database) and identify one or more account identifiers (e.g., an account ID number, a primary account number (PAN), or a virtual card number) associated with the user identifier and the user account. Each account identifier may correspond to a different sub-account, and each of the different sub-accounts may be associated with a particular account type (e.g., a checking account type, a credit account type, a savings account type, or a rewards account type). The account type may be associated with the particular account identifier in the user profile database. The processing system may identify the account type by accessing and obtaining the account information from the user profile database.

Additionally, or alternatively, one or more of the account identifiers may have an alert (e.g., a fraud alert, an overdraft alert, an impending action alert, or late payment alert) associated with the particular account identifier. For example, one or more of the different sub-accounts may have a required action (e.g., paying a balance, renewing an account, updating information, or submitting documentation) having an impending action date (e.g., a deadline date) within a threshold time frame (e.g., one month, 10 days, 3 days), and the account identifier corresponding to the particular sub-account may be flagged with an impending action alert in the user profile database. The processing system may identify the alert by accessing and obtaining the account information from the user profile database.

As shown in FIG. 1B and by reference number 115, for a user account that has more than one account identifier, the processing system may determine a primary account identifier of the multiple account identifiers based on the account information. The multiple account identifiers may each have a priority level (e.g., a rank), and the primary account identifier may be the account identifier associated with the highest priority level. The range of priority levels may be based on the number of account identifiers associated with the user account. For example, if the user account has three account identifiers, then the highest priority level may be three, the second priority level may be two, and the lowest priority level may be one. The priority levels may be based on one or more factors (e.g., alert, account totals, impending action date, or account type). Each factor may be assigned a particular weight. For example, an account identifier that has been flagged with an alert may receive a high weight (e.g., 5). Additionally, the weight may be determined based on the particular alert type. For example, a fraud alert may receive a greater weight (e.g., 5) than an impending action alert, such as related to a deadline (e.g., a payment date). Additionally, or alternatively, an account identifier that has an action date or deadline (e.g., a payment date) within a threshold time frame may receive a certain weight. The weight may depend on the threshold time frame. For example, an action date in 2 days may receive a high weight (e.g., 5), whereas an action date in 30 days may receive a low weight (e.g., 1). As another example, the different available account types may be assigned different weights. For example, a credit account type may receive a high weight (e.g., 3), a checking account type may receive an intermediate weight (e.g., 2), and a rewards account type may receive a low weight (e.g., 1). As another example, the account identifier associated with a particular sub-account having a highest account total (e.g., account balance or account rewards points) may receive the highest weight (e.g., 3), and the account identifier associated with the particular sub-account having a lowest account total may receive the lowest weight (e.g., 1). The weights of all of the factors for each account identifier may be totaled, and the priority level may be assigned in order of decreasing total (e.g., the account identifier with the highest total has the highest priority level). Alternatively, the weights of all of the factors may be averaged, and the priority level may be assigned in order of decreasing average (e.g., the account identifier with the highest average has the highest priority level).

In some implementations, the processing system may use a machine learning model to determine the priority levels. The machine learning model may be trained to determine a priority level for a particular account identifier based on historical training data, to determine the priority levels for the plurality of account identifiers based on one or more factors associated with the account information. The processing system may update the machine learning model based on feedback data (e.g., received from the user device).

As shown by reference number 120, the processing system may transmit, and the user device may receive, a first set of UI data. As shown in FIG. 1B, the first set of UI data may indicate, and the user device may display (e.g., on a display or UI of the user device), multiple account UI elements 125 (also referred to as interaction elements) corresponding to multiple account identifiers and sub-accounts associated with the user identifier. The account UI elements 125 may be arranged in a particular order based on the priority levels. A primary account UI element 130 may be arranged first in the order. For example, as shown in FIG. 1B, the account UI elements may be arranged in a stack in which one of the account UI elements may partially overlap an adjacent one of the account UI elements, and the primary account UI element 130 may be arranged on a top of the stack (e.g., no other account UI element overlaps the primary account UI element 130).

In some implementations, as shown in FIG. 1B, the account UI elements 125, as indicated by the first set of UI data, may include rectangular-shaped elements (also referred to as first rectangular-shaped elements). Reference number 135 corresponds to the first rectangular-shaped element of the primary account UI element 130, and reference number 140 corresponds to the first rectangular-shaped elements of the other account UI elements. In some implementations, the first rectangular-shaped elements 135 and 140 may have rounded corners, as shown in FIG. 1B. Alternatively, the first rectangular-shaped elements 135 and 140 may have square corners or chamfered corners. The first rectangular-shaped elements 135 and 140 may be visual representations of (e.g., have dimensions similar to) physical, rectangular-shaped cards (e.g., transaction cards) associated with the corresponding account identifiers. For example, the first rectangular-shaped elements 135 and 140 may have a width that is greater than a height of the rectangular-shaped elements 135 and 140. In implementations in which the account UI elements 125 are arranged in a stack (e.g., one account UI element overlapping another account UI element), the first rectangular-shaped element 135 of the primary account UI element 130 may have an area that is greater than an area of the first rectangular-shaped element 140 of the other account UI elements (e.g., due to the arrangement of the primary account UI element 130 on the top of the stack).

Additionally, or alternatively, as further shown in FIG. 1B, the account UI elements 125, as indicated by the first set of UI data, may include a first set of account information visually presented on the account UI elements 125 (e.g., within the first rectangular-shaped elements 135 and 140). Reference number 145 corresponds to the first set of account information associated with the primary account UI element 130, and reference number 150 corresponds to the first set of account information associated with the other account UI elements. The first sets of account information 145 and 150 may be associated with the account identifiers corresponding to the account UI elements on which the first set of account information is presented. For example, the first set of account information 145 associated with the primary account UI element 130 may be associated with the primary account identifier and the corresponding sub-account. The first sets of account information 145 and 150 may include any subset of account information associated with the account identifiers stored in the user profile database, for example, the account types, the account totals, and/or account alerts. In some implementations, the first set of account information 145 associated with the primary account UI element 130 may include more account information than the first set of account information 150 associated with any of the other account UI elements (for example, when the first rectangular-shaped element 135 of the primary account UI element 130 has a greater area than the area of the first rectangular-shaped elements 140 of the other account UI elements and/or when the account UI elements 125 are arranged in a stack).

As shown in FIG. 1C, each account UI element may be interactable by the user to select and access a particular sub-account and account information associated with the particular sub-account (e.g., additional account information not presented on the corresponding account UI element). For example, as shown by reference number 155, the user may select one of the account UI elements (e.g., by pressing the particular UI element on a touchscreen of the user device). The user device may detect the user interaction with the selected account UI element. As shown by reference number 160, the processing system may receive, from the user device, selection data indicating the selection, by the user, of the selected account UI element. The selection data may include or be accompanied by the particular account identifier (e.g., the selected account identifier) corresponding to the selected account UI element. Alternatively, the processing system may be able to determine the particular account identifier based on the selected account interface element indicated by the interaction data.

As shown by reference number 165, based on the user interaction with the selected account UI element and based on receiving the selection data from the user device, the processing system may obtain account data (e.g., from the user profile database) indicating account information associated with the selected account identifier. As shown by reference number 170, the processing system may transmit, to the user device, a second set of UI data to be displayed on the user device. As shown in FIG. 1C, the second set of UI data may indicate a rectangular-shaped element 175 (also referred to as a second rectangular-shaped element). In some implementations, the second rectangular-shaped element 175 may have rounded corners, as shown in FIG. 1C. Alternatively, the second rectangular-shaped element 175 may have square corners or chamfered corners. The second rectangular-shaped element 175 may be a visual representation of (e.g., have dimensions similar to) a physical, rectangular-shaped card (e.g., a transaction card) associated with the selected account identifier. For example, the second rectangular-shaped element 175 may have a width that is greater than a height of the second rectangular-shaped element 175. Additionally, or alternatively, the second set of UI data may indicate a second set of account information 180 visually presented within the second rectangular-shaped element. The second set of account information 180 may be associated with the selected account identifier.

In some implementations, the second rectangular-shaped element 175 may have an area that is substantially the same as the first rectangular-shaped element 135 of the selected account UI element (or second interaction element) (e.g., the first rectangular-shaped element 135 and the second rectangular-shaped element 175 are substantially the same size) (for example, when the selected account UI element is the primary account UI element 130). Alternatively, the second rectangular-shaped element 175 may have a larger area than an area of the first rectangular-shaped element 140 of the selected account UI element and/or the second set of information 180 may include more account information than the first set of account information 150 presented within the first rectangular-shaped element of the selected account UI element (e.g., when the selected account UI element is one of the other account UI elements).

Using the techniques described herein, a user device may present, on a UI, a UI element that provides user-friendly visualization of multiple accounts via account UI elements corresponding to the multiple accounts, each presenting relevant account information to the user. The account UI elements dynamically present information and are dynamically presented in an order to communicate an importance or priority of the accounts. As a result, the user does not have to navigate through multiple UIs to determine important information regarding the accounts and, therefore, computing memory and resources may be efficiently used.

As indicated above, FIGS. 1A-1C are provided as an example. Other examples may differ from what is described with regard to FIGS. 1A-1C. For example, although implementations are described herein in connection with the first and second sets of UI data indicating rectangular-shaped elements, techniques described herein may be used for any shape (e.g., a circle, oval, square, or non-geometric shape).

FIG. 2 is a diagram of an example environment 200 in which systems and/or methods described herein may be implemented. As shown in FIG. 2, environment 200 may include a processing system 210, a user profile database 220, a user device 230, and a network 240. Devices of environment 200 may interconnect via wired connections, wireless connections, or a combination of wired and wireless connections.

The processing system 210 includes one or more devices capable of receiving, generating, storing, processing, providing, and/or routing information associated with presentation and control of user interaction with a user interface element, as described elsewhere herein. The processing system 210 may include a communication device and/or a computing device. For example, the processing system 210 may include a server, such as an application server, a client server, a web server, a database server, a host server, a proxy server, a virtual server (e.g., executing on computing hardware), or a server in a cloud computing system. In some implementations, the processing system 210 includes computing hardware used in a cloud computing environment.

The user profile database 220 includes one or more devices capable of receiving, generating, storing, processing, and/or providing information associated with presentation and control of user interaction with a user interface element, as described elsewhere herein. The user profile database 220 may include a communication device and/or a computing device. For example, the user profile database 220 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the user profile database 220 may store information associated with user and/or one or more accounts of a user, such as interaction data associated with interactions between the user and an interaction party, as described elsewhere herein.

The user device 230 includes one or more devices capable of receiving, generating, storing, processing, and/or providing information associated with presentation and control of user interactions with a time-dependent user interface element, as described elsewhere herein. The user device 230 may include a communication device and/or a computing device. For example, the user device 230 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 240 includes one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200. The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to processing system 210, user profile database 220, and/or user device 230. In some implementations, processing system 210, user profile database 220, and/or user device 230 include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

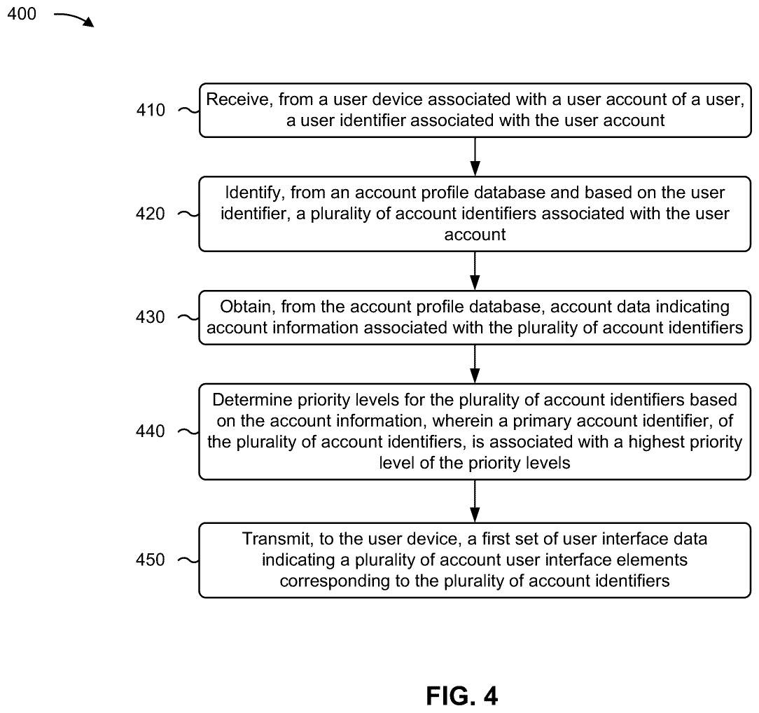

FIG. 4 is a flowchart of an example process 400 associated with presentation and control of user interaction. In some implementations, one or more process blocks of FIG. 4 may be performed by the processing system 210. In some implementations, one or more process blocks of FIG. 4 may be performed by another device or a group of devices separate from or including the processing system 210, such as the user device 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving, from a user device associated with a user account of a user, a user identifier associated with the user account (block 410). For example, the processing system 210 (e.g., using processor 320, memory 330, input component 340, and/or communication component 360) may receive, from a user device associated with a user account of a user, a user identifier associated with the user account, as described above in connection with reference number 105 of FIG. 1A. As an example, the user device may transmit, and the processing system may receive, the user identifier, such as when the user logs into the user account (e.g., via the application installed on the user device or via the web-based application).

As further shown in FIG. 4, process 400 may include identifying, from a user profile database and based on the user identifier, a plurality of account identifiers associated with the user account (block 420). For example, the processing system 210 (e.g., using processor 320 and/or memory 330) may identify, from a user profile database and based on the user identifier, a plurality of account identifiers associated with the user account, as described above in connection with reference number 110 of FIG. 1A. As an example, based on the user identifier, the processing system may access account information associated with the user identifier and the user account (e.g., from the user profile database) and identify one or more account identifiers (e.g., an account ID number, a PAN, or a virtual card number) associated with the user identifier and the user account.

As further shown in FIG. 4, process 400 may include obtaining, from the user profile database, account data indicating account information associated with the plurality of account identifiers (block 430). For example, the processing system 210 (e.g., using processor 320 and/or memory 330) may obtain, from the user profile database, account data indicating account information associated with the plurality of account identifiers, as described above in connection with reference number 110 of FIG. 1A. As an example, each account identifier may correspond to a different sub-account, and each of the different sub-accounts may be associated with a particular account type (e.g., a checking account type, a credit account type, a savings account type, or a rewards account type). The account type may be associated with the particular account identifier in the user profile database. The processing system may identify the account type by accessing and obtaining the account information from the user profile database. Additionally, or alternatively, one or more of the account identifiers may have an alert (e.g., a fraud alert, an overdraft alert, an impending action alert, or late payment alert) associated with the particular account identifier. The processing system may identify the alert by accessing and obtaining the account information from the user profile database.

As further shown in FIG. 4, process 400 may include determining priority levels for the plurality of account identifiers based on the account information, wherein a primary account identifier, of the plurality of account identifiers, is associated with a highest priority level of the priority levels (block 440). For example, the processing system 210 (e.g., using processor 320 and/or memory 330) may determine priority levels for the plurality of account identifiers based on the account information, wherein a primary account identifier, of the plurality of account identifiers, is associated with a highest priority level of the priority levels, as described above in connection with reference number 115 of FIG. 1B. As an example, for a user account that has more than one account identifier, the processing system may determine a primary account identifier of the multiple account identifiers based on the account information. The multiple account identifiers may each have a priority level (e.g., a rank), and the primary account identifier may be the account identifier associated with the highest priority level.

As further shown in FIG. 4, process 400 may include transmitting, to the user device, a first set of UI data indicating a plurality of account UI elements corresponding to the plurality of account identifiers (block 450). The first set of UI data may indicate an order of the plurality of account UI elements based on the priority levels of the plurality of account identifiers. A primary account UI element, of the plurality of account UI elements and corresponding to the primary account identifier, may be arranged first in the order. The first set of UI data may indicate, for the plurality of account UI elements, a first set of the account information to be visually presented on the plurality of account UI elements. The first set of the account information may be associated with the plurality of account identifiers corresponding to the plurality of account UI elements. For example, the processing system 210 (e.g., using processor 320, memory 330, and/or communication component 360) may transmit, to the user device, a first set of UI data indicating a plurality of account UI elements corresponding to the plurality of account identifiers, as described above in connection with reference number 120 of FIG. 1B. As an example, the first set of UI data may indicate, and the user device may display (e.g., on a display or UI of the user device), multiple account UI elements 125 (also referred to as interaction elements) corresponding to multiple account identifiers and sub-accounts associated with the user identifier. The account UI elements 125 may be arranged in a particular order based on the priority levels. A primary account UI element 130 may be arranged first in the order. Additionally, the account UI elements 125, as indicated by the first set of UI data, may include a first set of account information visually presented on the account UI elements 125.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C.

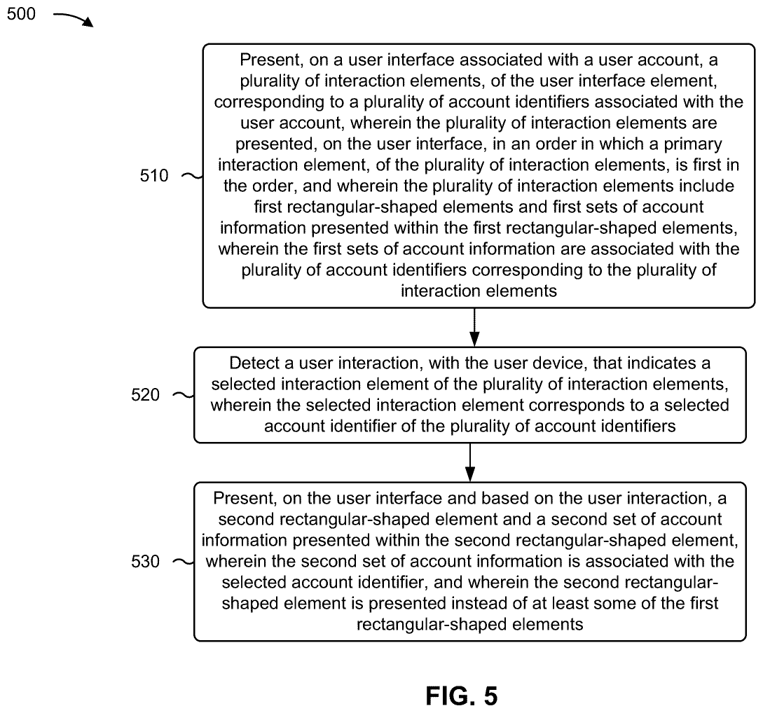

FIG. 5 is a flowchart of an example process 500 associated with presentation and control of user interaction with a user interface element. In some implementations, one or more process blocks of FIG. 5 may be performed by a user device (e.g., user device 230). In some implementations, one or more process blocks of FIG. 5 may be performed by another device or a group of devices separate from or including the user device, such as processing system 210. Additionally, or alternatively, one or more process blocks of FIG. 5 may be performed by one or more components of device 300, such as processor 320, memory 330, input component 340, output component 350, and/or communication component 360.

As shown in FIG. 5, process 500 may include presenting, on a UI associated with a user account, a plurality of interaction elements, of a UI element, corresponding to a plurality of account identifiers associated with the user account (block 510). The plurality of interaction elements may be presented, on the user interface, in an order in which a primary interaction element, of the plurality of interaction elements, is first in the order. The plurality of interaction elements may include first rectangular-shaped elements and first sets of account information presented within the first rectangular-shaped elements, wherein the first sets of account information may be associated with the plurality of account identifiers corresponding to the plurality of interaction elements. For example, the user device 230 (e.g., using processor 320 and/or memory 330) may present, on a UI associated with a user account, a plurality of interaction elements, of a UI element, corresponding to a plurality of account identifiers associated with the user account, as described above in connection with FIG. 1B. As an example, the UI element may include multiple interaction elements 125 corresponding to multiple account identifiers and sub-accounts associated with the user identifier. The interaction elements 125 may be arranged in a particular order, wherein a primary interaction element 130 may be arranged first in the order. The interaction elements 125 may include rectangular-shaped elements. Additionally, the account interaction elements 125 may include first sets of account information visually presented within the rectangular-shaped elements.

As further shown in FIG. 5, process 500 may include detecting a user interaction, with the user device, that indicates a selected interaction element of the plurality of interaction elements, wherein the selected interaction element corresponds to a selected account identifier of the plurality of account identifiers (block 520). For example, the user device 230 (e.g., using processor 320 and/or memory 330) may detect a user interaction, with the user device, that indicates a selected interaction element of the plurality of interaction elements, as described above in connection with reference number 155 in FIG. 1C. As an example, the user may select one of the interaction elements (e.g., by pressing the particular interaction element on a touchscreen of the user device). The user device may detect the user interaction with the selected interaction element.

As further shown in FIG. 5, process 500 may include presenting, on the UI and based on the user interaction, a second rectangular-shaped element and a second set of account information presented within the second rectangular-shaped element (block 530). The second set of account information may be associated with the selected account identifier, and the second rectangular-shaped element may be presented instead of at least some of the first rectangular-shaped elements. For example, the user device 230 (e.g., using processor 320 and/or memory 330) may present, on the UI and based on the user interaction, a second rectangular-shaped element and a second set of account information presented within the second rectangular-shaped element, as described above in connection with reference numbers 175 and 180 in FIG. 1C. As an example, the user device may present on the UI a second rectangular-shaped element 175 and a second set of account information 180 within the second rectangular-shaped element.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C.

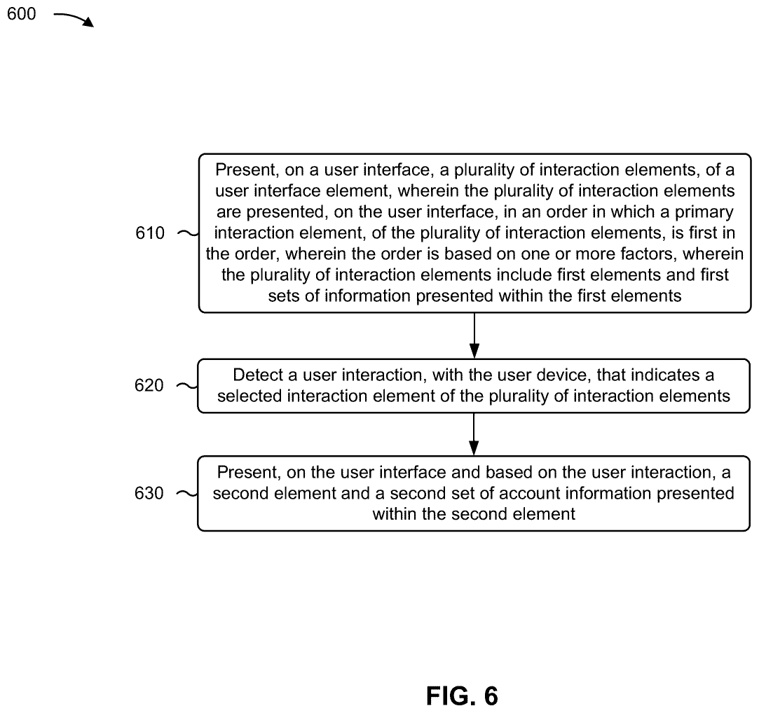

FIG. 6 is a flowchart of an example process 500 associated with presentation and control of user interaction with a user interface element. In some implementations, one or more process blocks of FIG. 6 may be performed by a user device (e.g., user device 230). In some implementations, one or more process blocks of FIG. 6 may be performed by another device or a group of devices separate from or including the user device, such as processing system 210. Additionally, or alternatively, one or more process blocks of FIG. 6 may be performed by one or more components of device 300, such as processor 320, memory 330, input component 340, output component 350, and/or communication component 360.

As shown in FIG. 6, process 600 may include presenting, on a UI associated with a user account, a plurality of interaction elements, of a UI element (block 610). The plurality of interaction elements may be presented, on the UI, in an order (e.g., in a stacked and/or overlapping formation) in which a primary interaction element, of the plurality of interaction elements, is first in the order (e.g., on a top of the stacked and/or overlapping formation). The order may be based on one or more factors. The plurality of interaction elements may include first elements and first sets of information presented within the first elements. The first element of the primary interaction element may have a larger area than an area of the first element of the other interaction elements and/or the first set of information presented within the first element of the primary interaction element may include more information than the first set of information presented within the first elements of the other interaction elements. For example, the user device 230 (e.g., using processor 320 and/or memory 330) may present, on a UI associated with a user account, a plurality of interaction elements, of a UI element, as described above in connection with FIG. 1B. As an example, the UI element may include multiple interaction elements 125 presented in a particular order, wherein a primary interaction element 130 may be arranged first in the order.

As further shown in FIG. 6, process 600 may include detecting a user interaction, with the user device, that indicates a selected interaction element of the plurality of interaction elements (block 620). For example, the user device 230 (e.g., using processor 320 and/or memory 330) may detect a user interaction, with the user device, that indicates a selected interaction element of the plurality of interaction elements, as described above in connection with reference number 155 in FIG. 1C. As an example, the user may select one of the interaction elements (e.g., by pressing the particular interaction element on a touchscreen of the user device). The user device may detect the user interaction with the selected interaction element.

As further shown in FIG. 6, process 600 may include presenting, on the user interface and based on the user interaction, a second element and a second set of information presented within the second element (block 630). In some implementations, the second element may have an area that is substantially the same as the first element of the selected interaction element (e.g., when the selected interaction element is the primary interaction element). Alternatively, the second element may have a larger area than an area of the first element of the selected interaction element and/or the second set of information may include more information than the first set of information presented within the first element of the selected interaction element (e.g., when the selected interaction element is one of the other interaction elements). For example, the user device 230 (e.g., using processor 320 and/or memory 330) may present, on the UI and based on the user interaction, a second element and a second set of information presented within the second element, as described above in connection with reference numbers 175 and 180 in FIG. 1C.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1C.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device comprising:
one or more memories; and
one or more processors, coupled to the one or more memories, configured to:
dynamically present, based on priority levels associated with a plurality of account identifiers associated with an account, a plurality of interaction elements corresponding to the plurality of account identifiers,
wherein the priority levels are determined based on:
a first weight based on a type of alert associated with a primary account identifier of the plurality of account identifiers,
a second weight based on a type of account associated with the primary account identifier, and
a third weight based on a threshold time frame associated with an action date associated with the primary account identifier, and
wherein a primary interaction element, of the plurality of interaction elements and associated with the primary account identifier, overlaps a secondary interaction element, of the plurality of interaction elements and associated with a secondary account identifier of the plurality of account identifiers, based on the priority levels;
modify, based on detecting a selection of the secondary interaction element, the dynamic presentation of the plurality of interaction elements; and
display, based on the modification, account information associated with the secondary account identifier.

2. The device of claim 1, wherein display of the account information was overlapped by the primary interaction element prior to the modification.

3. The device of claim 1, wherein each of the plurality of interaction elements is associated with account information related to a corresponding account identifier of the plurality of account identifiers.

4. The device of claim 1, wherein the primary interaction element includes a first area that is larger than a second area of the secondary interaction element prior to the modification.

5. The device of claim 1, wherein the secondary interaction element includes a second area that is larger than a first area of the primary interaction element after the modification.

6. The device of claim 1, wherein the plurality of interaction elements includes rounded corners to form a visual representation of transaction cards.

7. The device of claim 1, wherein the type of alert includes at least one of:
a fraud alert, or
an impending action alert.

8. A non-transitory computer-readable medium storing a set of instructions, the set of instructions comprising:
one or more instructions that, when executed by one or more processors of a device, cause the device to:
dynamically present, based on priority levels associated with a plurality of account identifiers associated with an account, a plurality of interaction elements corresponding to the plurality of account identifiers,
wherein the priority levels are determined based on:
a first weight based on a type of alert associated with a primary account identifier of the plurality of account identifiers,
a second weight based on a type of account associated with the primary account identifier, and
a third weight based on a threshold time frame associated with an action date associated with the primary account identifier, and
wherein a primary interaction element, of the plurality of interaction elements and associated with the primary account identifier, overlaps a secondary interaction element, of the plurality of interaction elements and associated with a secondary account identifier of the plurality of account identifiers, in a vertical stack based on the priority levels;
modify, based on a selection of the secondary interaction element, the dynamic presentation of the plurality of interaction elements; and
display, based on the modification, account information associated with the secondary account identifier.

9. The non-transitory computer-readable medium of claim 8, wherein display of the account information was overlapped by the primary interaction element prior to the modification.

10. The non-transitory computer-readable medium of claim 8, wherein each of the plurality of interaction elements is associated with account information related to a corresponding account identifier of the plurality of account identifiers.

11. The non-transitory computer-readable medium of claim 8, wherein the primary interaction element includes a first area that is larger than a second area of the secondary interaction element prior to the modification.

12. The non-transitory computer-readable medium of claim 8, wherein the secondary interaction element includes a second area that is larger than a first area of the primary interaction element after the modification.

13. The non-transitory computer-readable medium of claim 8, wherein the one or more instructions further cause the device to round corners to form a visual representation of transaction cards.

14. The non-transitory computer-readable medium of claim 8, wherein the type of alert includes at least one of:
a fraud alert, or
an impending action alert.

15. A method, comprising:
dynamically presenting, by a device, based on priority levels associated with a plurality of account identifiers associated with an account, a plurality of interaction elements corresponding to the plurality of account identifiers,
wherein the priority levels are determined based on:
a first weight based on a type of alert associated with a primary account identifier of the plurality of account identifiers,
a second weight based on a type of account associated with the primary account identifier, and
a third weight based on a threshold time frame associated with an action date associated with the primary account identifier, and
wherein a primary interaction element, of the plurality of interaction elements and associated with the primary account identifier, overlaps a secondary interaction element, of the plurality of interaction elements and associated with a secondary account identifier of the plurality of account identifiers, in a vertical stack based on the priority levels;
modifying, by the device and based on detecting a selection of the secondary interaction element, the dynamic presentation of the plurality of interaction elements; and
displaying, by the device and based on the modification, account information associated with the secondary account identifier.

16. The method of claim 15, wherein display of the account information was overlapped by the primary interaction element prior to the modification.

17. The method of claim 15, wherein each of the plurality of interaction elements is associated with account information related to a corresponding account identifier of the plurality of account identifiers.

18. The method of claim 15, wherein the primary interaction element includes a first area that is larger than a second area of the secondary interaction element prior to the modification.

19. The method of claim 15, wherein the secondary interaction element includes a second area that is larger than a first area of the primary interaction element after the modification.

20. The method of claim 15, comprising rounding corners to form a visual representation of transaction cards.
